(19) United States
(12) Patent Application Publication
(10) Pub. No.: US 2025/0342005 A1
(43) Pub. Date: Nov. 6, 2025

(54) METHOD AND A SYSTEM FOR ELICITING CONSENT FROM A USER TO ALLOW A PERSONAL CONNECTED OBJECT OF THE USER TO EXECUTE AN INSTRUCTION

(71) Applicant: 360 of Me, Inc., Detroit, MI (US)

(72) Inventor: Philippe Miliau Georges LE BERRE, Versoix (CH)

(21) Appl. No.: 18/656,228

(22) Filed: May 6, 2024

(51) Int. Cl. G06F 3/16

(52) U.S. Cl. CPC G06F 3/167; G06F 3/165

(57) ABSTRACT

The present document discloses systems and methods which deliver notifications to individuals' personal connected objects to cause a personal connected object to execute given instructions provided that the individual who is authorised to use the personal connected object gives their consent. Embodiments described herein make use of intermediary connected objects to receive the instructions and to further forward the instructions to the personal connected objects via audio-based communications.

### TECHNICAL DOMAIN

The concepts described herein relate generally to the field of digital data processing, especially when applied to systems for providing electronic notifications. More particularly, systems and methods described herein provide for machine interface arrangements involving propagating acoustic waves. Some embodiments also involve audio encoding techniques and electronic communication techniques.

### BACKGROUND

Audible notifications play a pivotal role in alerting individuals to potential dangers or in conveying important information in certain situations within many different settings such as in public spaces like train stations or stadiums or in private spaces such as in an office or in a car, for example. Audio broadcasts may announce important information in a stadium, a telephone ring may signal the arrival of an important personal call in an office environment, or a beep or a honk may serve to alert a driver of a car as to an anomaly with the engine or to warn a pedestrian of the presence of the car on the road, for example. However, the usefulness of such audible notifications depends on the listener's ability to interpret or otherwise differentiate the meanings of the different possible alert sounds or to understand the language that may be used in the audible notification.

In the domain of vehicle safety, particularly with recent advancements in technologies for communication between a vehicle and any entity that may affect, or may be affected by, the vehicle, such as in Vehicle-to-Everything technology (V2X), communications generally rely on wireless communication technologies such as Bluetooth, Wi-Fi and cellular or other WLAN communications means. Audible signals, such as car honks and natural engine sounds have traditionally served as vital warnings for pedestrians and other drivers. In the case of electric vehicles, supplementary sounds are sometimes added to alert pedestrians of the presence of the otherwise silent vehicles. Audible signals, in the form of alert sounds, are often used inside all types of vehicles, sometimes complementing visual indicators, to alert drivers as to anomalies, malfunctions or other potential hazards in or around the vehicle. However, as mentioned above, the usefulness of audible alert sounds for communicating important information depends on drivers' abilities to properly interpret these sounds and the meanings behind them.

Connected objects equipped with speakers and microphones, such as smartphones or surveillance cameras, are well known, and great use has been made of their ability to respond to audio-based commands to execute instructions and to cause other connected objects to perform certain functions, thereby opening up a world of audio-based interactivity. Voice-activated assistants, in particular, may provide for auditory cuing thus facilitating user engagement via self-activation triggered by specific pre-determined sounds.

Also related to the domain of audio coding, music recognition platforms are known where audio is used as a medium for convenient and secure interaction. Known music recognition technology is based on audio fingerprinting. Audio fingerprinting usually involves the use of locality sensitive hashing of parts of the audio sample where frequency peaks occur, which are parts of the sample containing the most relevant information for allowing that piece of music to be characterised and therefore identified. This means that audio fingerprints are resilient to sound intensity increases or decreases, as well as to noise, which makes it possible for music recognition applications to work well even in noisy environments, such as inside a vehicle while it is being driven.

Audio, as a medium, also allows for the realisation of certain anti-piracy measures through the use of various types of audio watermarking techniques. Audio watermarking makes it possible for musical content to be authenticated by the presence of audibly imperceptible metadata embedded within the digital audio files containing the musical content. Thus, the musical content can be automatically identified, and this without interfering with the listener's enjoyment of the musical content.

The technique of including audibly imperceptible data within an audio file, used to achieve watermarking, has also been exploited in the domain of broadcasting where it is sometimes sought to discretely, sometime surreptitiously, deliver commercial advertising content to an audience using computer instructions encoded into an audio content in such a way that the instructions are inaudible to a human listener when the broadcast content is decoded and played back. An example of this type of technology is disclosed in United States Patent publication number US10909566B2, which aims to provide a solution to advertisers to allow them to deliver commercial messages to consumers along with audio content in a way that does not interrupt the consumer's enjoyment of the audio content. The audio content is broadcast to presentation devices, which play the content. Within the audio content, extra data is included and encoded as one or more tones which are inaudible to a human listener. On the other hand, the tones can be detected and decoded by a computing device of the consumer to provide the extra data. The extra data may cause the consumer's computing device to display a commercial message or to perform an action such as launching an application or launching a website or launching a widget.

Similar technology is disclosed in United States Patent Application Publication number 20104019127A1, where a digital media file containing a message is broadcast to playback devices. The message is encoded into the media file such that it is inaudible to a human listener when the media file is played, but a computing device can detect and decode the message containing commercial information encouraging the consumer to interact in some way, which may include providing identifying information.

The existence of such technology clearly underscores the necessity for improvements in the enforcement of individuals' rights for deciding how their information is used and for deciding which functions can be executed by their personal connected objects, as mandated by specific regulations on such matters, such as the General Data Protection Regulation, for example.

Given that much of the above-mentioned technology has generally received wide acceptance by users of personal connected objects such as smartphones, for example in applications involving audio-based transactions, it is important not to lose sight of issues related to consent. Indeed, the automatic granting of perpetual listening rights to smartphones or other personal connected objects raises valid concerns with respect to users' privacy. This is exemplified, for example, by reports of successful attacks on systems incorporating voice-activated technology, where certain weaknesses in aspects related to the use of inaudible sounds have been successfully exploited by ill-intentioned parties with disastrous effect.

Consequently, there remains a need for a solution for providing a safe environment for users of personal connected objects to interact with the connected object for executing functions in response to receiving a notification. Preferably, the solution should allow for a third party to deliver targeted and relevant notifications to personal connected objects of concerned users without the particular user being known or identifiable by the third party and without the users having to pair their personal connected objects with any other devices just for the purpose of receiving the notifications. The solution should also ensure that the user's privacy rights are respected and should allow for the users to provide their permission for their personal connected objects to execute any functions as a result of having received the notification.

### BRIEF SUMMARY

Given the need for users of personal connected objects, such as smartphones or connected watches and the like, to be able to preserve their rights regarding the use of their information and to be able to have control over the provision of consent during digital interactions using their connected objects, the present disclosure discusses techniques involving the use of audible notifications for digital interactivity. The techniques allow for pertinent notifications to be sent to concerned users without it being necessary for the user to be known by the sender of the notifications and without the user having to pair their personal connected objects with any other connected object just for the purpose of being able to receive the notification. By employing audible signals in the manner described herein, provision is made for transparency and user awareness of such notifications and the effects that they may have on their personal connected objects, mitigating the privacy risks that exist in the prior art where personal connected objects are often expected to allow perpetual audio monitoring. This approach not only enhances user control over the user's digital environment but also aligns with regulatory requirements for privacy protection in the digital realm.

According to a first aspect, there is disclosed herein a method for eliciting consent from a user to allow a personal connected object of the user to execute an instruction, the method comprising communication of the instruction to said personal connected object, said communication including:
receiving at one or more predetermined electronically addressable intermediary connected objects located at one or more target environments, via an electronic communication channel, an audio tag comprising:
   an audio encoded notification comprising the instruction; and
   an audio encoded alert sound;
decoding and playing the audio tag by the intermediary connected object, thus propagating an audio signal towards the personal connected object over a propagation path in the target environment, the audio signal comprising an audible component and an inaudible component as perceivable by a person located within the propagation path, the audible component comprising the alert sound and the inaudible component comprising the audio encoded notification;
receiving the propagated audio signal by a microphone of the personal connected object;
recognizing, by the personal connected object, that the audio signal comprises an audio tag or that the audio signal comprises an audio encoded alert sound;
arranging, by the personal connected object, for the instruction within the audio encoded notification in the audio tag to be obtained;
presenting, by the personal connected object, the instruction to the user for the user to provide said consent.

According to an embodiment, the method also comprises using the personal connected object to request the user to provide their consent for executing the instruction and only executing the instruction on condition that the user provides their consent. The request may be made using a display of the personal connected object to show a message to the user, asking for consent. The request may otherwise be made using vocal communications between the personal connected object and the user, where the message is played by the personal connected object for the user to hear. Thus, it is possible to prevent the execution of the instruction unless specific consent is obtained.

According to an embodiment, the intermediary connected object receives the audio tag from a notification server. A third party who wants to send a notification to users who are likely to have an interest in receiving the notification would first send a notification request to the notification server. The notification request may comprise an instruction that the third party would like the user to execute on their personal connected object and it may further comprise a message intended to be shown or played to the user by their personal connected object to explain why they have received a notification and/or asking the user to provide their consent for their personal connected object to execute the instruction comprised within the notification request. The notification server then prepares the audio tag by combining an alert sound and the notification into an audio encoded message, which when decoded and played provides an audio signal having an audible component and an inaudible component. The alert sound appears in the audible component of the audio signal and the notification appears in the inaudible component of the audio signal. The alert sound may be customizable in the sense that it may be selected or generated depending on the type of notification to be provided, such that different notification types could be recognizable by the different alert sounds played by the intermediary connected object. According to an embodiment, the alert sound is a customized based on the type of notification to be provided and/or the intermediary connected object to which the audio tag is addressed. The selection of the alert sound may be performed using one or more sound generative AI operations.

According to another aspect, there is provided a non-transitory machine-readable medium having stored thereon machine-readable instructions executable to cause a machine to perform the method described above.

According to yet another aspect, provision is made for a propagating audio signal comprising an audible component and an inaudible component as perceivable by a person located within a propagation path along which the audio signal propagates, the audible component comprising an alert sound, the inaudible component comprising an audio encoded notification comprising an instruction executable by a processor.

According to an aspect, a system for eliciting consent from a user to allow a personal connected object of the user to execute an instruction is provided. The personal connected object of this system comprises a microphone. The system further comprises an intermediary connected object and a notification server. The intermediary connected object has a speaker and is configured to receive an audio tag from the notification server via an electronic communication channel. The audio tag comprises on one hand an audio encoded notification comprising the instruction and on the other hand an audio encoded alert sound. In this system, the intermediary connected object is configured to play the audio tag, thus propagating an audio signal towards the personal connected object, the audio encoded alert sound being audible within the audio signal and the audio encoded notification being inaudible within the audio signal. Finally, in this system, the personal connected object is configured to recognize that the audio signal comprises the audio encoded notification and to obtain the instruction encoded within the audio encoded notification and to seek the consent from the user of the personal connected object to execute the instruction.

According to still another aspect, an intermediary connected object is provided for use in the system described above.

According to an aspect, a personal connected object is provided for use in the system described above.

An electronic communication channel can be any communication channel allowing for electrical communication using a time-varying signal, in other words a communication channel which uses wires as a medium. An electronic communication channel may also be any communication channel allowing for communication via electromagnetic radiation, in other words a wireless communication channel. This is as opposed to an audio communication channel: although audio communication channels may also be said to be wireless communication channels, they are not electronic communication channels as they rely on the transmission of information using audio signals by time modulation of pressure in a propagation path in the atmosphere between a source and a receiver, which neither involves the use of wires nor electromagnetic radiation as a medium.

### BRIEF DESCRIPTION OF THE DRAWINGS

The concepts described herein will be better understood thanks to the detailed description which follows, along with the accompanying drawings, in which the following is shown:

FIG. 1, showing a high-level schematic diagram of a system in which an embodiment described herein may be deployed;

FIG. 2, illustrating a schematic representation of an embodiment of a notification server which may be deployed in a system as described herein and the functions the notification server may perform;

FIG. 3, showing a flowchart of operations which may be carried out by an intermediary connected object as described herein; and

FIG. 4, in which a schematic representation of operations which may be performed by a personal connected object configured to operate according to an embodiment described herein to deliver a notification and to interact with a user.

### DETAILED DESCRIPTION

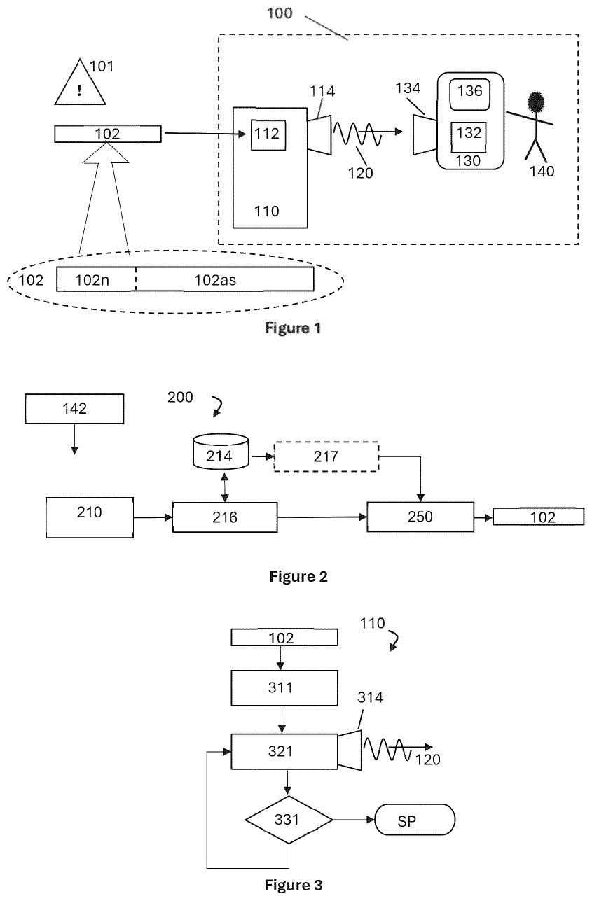

FIG. 1 illustrates in schematic form, a situation where an event 101 takes place somewhere, and a third party wishes to inform one or more users 140 of personal connected objects about the event by interacting with their personal connected object 130. A personal connected object may be a smartphone or a connected watch, for example. The user, or users, that the third party wishes to target are people who find themselves within a particular environment which, by virtue of their mere presence in that environment, qualifies that person as having a potential interest in knowing about, and possibly reacting to, the event. The environment is known as the target environment 100. Examples of target environments include stores, a store of a particular brand, public transport stations, a car, a car of a particular brand, and so on. More generally, a target environment can be any environment in which a connected object is located and where that connected object is known to the third party or at least the third party is able to address an electronic communication to the connected object. This addressable connected object, located in the target environment, is a different connected object from the user's personal connected object, which is mobile with the user.

A goal is for the third party to be able to interact with the personal connected object of the user, or personal connected objects of the users, in the target environment by intermediary of the addressable connected object. The addressable connected object may therefore also be called an intermediary connected object 110. Embodiments disclosed herein thus allow for a third party to interact with personal connected objects of users who may not necessarily be known to the third party, but who find themselves located close to an intermediary connected object and, as such, are potentially interested in receiving the notification and in allowing their personal connected object to proceed with such an interaction.

The intermediary connected object comprises a communications receiver for receiving messages via an electronic communications channel. The electronic communications channel may be a communications channel which uses one or more wires, or it may be a wireless communications channel, which allows the intermediary connected object to receive messages which are addressed to it. According to embodiments, this electronic communications channel is used by the intermediary connected object to receive electronic messages containing audio encoded information, which when decoded and played, present an audio signal. The intermediary connected object further comprises one or more processors for decoding the audio encoded messages, as well as a speaker for playing audio content decoded from the received messages, thus propagating an audio signal in the target environment.

To interact with the personal connected object of a user, the third party uses an electronic communication channel to send a notification about the event to one or more intermediary connected objects located in one or more target environments in which users who potentially could be interested in receiving such a notification may find themselves. As mentioned above, the people for whom the notification may be relevant are not necessarily known to the third party, but the people's mere presence in the target environment is enough for them to qualify as being potential target recipients of the notification. In some cases, they may even have a genuine interest in receiving the notification. The notification may comprise at least one instruction executable by a processor, and it is a goal of the third party to have the instruction executed by a personal connected object of the user who receives the notification. As well as the instruction, the notification may include a message to be communicated to the user to inform them about the notification and/or to ask their permission to allow their personal connected object to execute the instruction.

As illustrated in FIG. 1, for the purpose of sending the notification to the intermediary connected object 110, the notification is encoded, using an audio encoding algorithm, to form part of an audio tag 102 and the audio tag is sent to the intermediary connected object by way of an electronic communication channel. FIG. 1 includes an expanded view of the audio tag to show different parts of the audio tag. As well as the audio encoded notification 102n, the audio tag 102 also includes an audio encoded alert sound 102as. The encoded notification 102n and the encoded alert sound 102as are combined to form the audio tag 102 in such a way that when the audio tag is decoded and played by the intermediary connected object 110, thereby propagating an audio signal 120 along a propagation path in the target environment, the audio signal thus produced will have an audible component in which the alert sound is reproduced and which will be audible to a person 140 in the propagation path, and it will also have an inaudible component in which the notification will appear. The notification will be inaudible to the person in the propagation path but a suitably configured processor of a device having a microphone 134, which detects the audio signal, will be able to decode it. According to an embodiment, the user's personal connected object 130 is configured to decode the audio signal, including its inaudible component, thereby allowing for the personal connected object to discover the notification.

The user, having heard the alert sound, will be aware that his or her personal connected object just received a notification, probably comprising an instruction for their personal connected object to execute and they may then provide their consent for the personal connected object to execute the instruction. It is possible to arrange for different alert sounds to be used for different types, or categories, of notifications so that the user already may know, from the particular sound of the alert sound, what type of notification is being picked up by the personal connected object. According to an embodiment, where the notification also comprises a message, the personal connected object may display the message, or play the message, to the user to confirm that a notification was received, and to inform the user that they are required to make it known whether they provide their consent for an instruction in the notification to be executed by their personal connected object. The message may be played to the user of the personal connected object, for example audibly, or otherwise displayed to the user. The user may provide their consent by manually entering commands on their personal connected object or by interacting vocally with their personal connected object.

Referring again to FIG. 1, the audio tag 102 from the third party comprises, in audio encoded form, the notification 102n, which in turn comprises the instruction to be executed by the personal connected objects 130 of the users 140 who receive the audio tag and may further comprise a message designed to inform said recipient 140 of the arrival of the audio tag 102 and to request that the recipient give his or her consent to allow their personal connected object to execute the instruction comprised within the audio tag. The audio tag is also associated with an alert sound, the alert sound further being comprised, in audio encoded form, within the audio tag.

The audio encoded alert sound and the audio encoded instruction are combined, mixed or otherwise blended together into the audio tag such that when the audio tag is decoded by the intermediary connected object which receives it, an audio signal is propagated via the connected object's speaker into the target environment, the audio signal having an audible component in which the alert sound will appear and an inaudible component in which the notification will appear. By audible and inaudible it means audible or inaudible to a person in the propagation path of the audio signal. The person shown in FIG. 1 will therefore hear the alert sound in the audible component of the audio signal decoded from the audio tag and the person's suitably configured personal connected object will also pick up the audio signal, via a microphone, and will be able to decode the notification from the inaudible part of the audio signal. The person will recognise that their personal connected object will be reacting to a notification being received because they recognise the alert sound that they just heard. According to an embodiment where the personal object listens permanently in the background, the personal connected object will decode the audio tag automatically. In other embodiments where the personal connected object is set not to allow its microphone to be used in the background without permission, it is the through the user reacting to having heard the alert signal that will cause them to then set their personal connected object into a mode which will at least temporarily allow the microphone to be used to pick up the audio signal, decode it and process the information in the audio tag. After decoding the audio tag, the personal connected object may then display a message for the user or play a message for the user. They may then consult their personal connected object to see what the notification was, expecting in all probability to be asked to provide their consent to allow their personal connected object to execute an instruction which was also present in the notification.

The target environment may be inside a store or a theatre or a train station or inside a particular vehicle or inside one or more vehicles from a group of vehicles located anywhere near a particular town or near a particular junction, for example. The intermediary connected objects within the target environment may also be called predetermined connected objects since they are already known to, or at least addressable by, the third party. In embodiments which make use of a notification server, the third party does not have to know the intermediary connected objects: instead, the third party merely has to provide in its notification request an identifier of the target environment or an identifier of a type of target environment, covering a plurality of different potential target environments, and the notification server identifies the intermediary connected objects in the relevant target environments. Thus, the third party is able to address a communication to an intermediary connected object or to a group of intermediary connected objects at different places. Any known electronic communications means may be used to address messages to the intermediary connected objects, such as a wireless communication means or a wired communication means. As such, the intermediary connected objects may be referred to as predetermined electronically addressable connected objects.

For example, the intermediary connected object may be a car radio with an internet connection for receiving messages. The car radio may have access to a GPS within the car and so is able to determine the geographical location of the car at any given time. The third party may be a car manufacture who wants to send a notification to any people travelling in a car made by the car manufacturer, which happens to be in a particular town. The third party can therefore address a message to all car radios in cars of a certain type which happen to be in the particular town, for example.

According to an embodiment described herein, a notification server may be used to receive requests to issue notifications, then generate and send out corresponding notifications. The notification may be an instruction for execution on a processor, more particularly for execution on a personal connected object of a person (user) who receives the notification. The notification may further include a message which may be used by the personal connected object which receives the notification to either display or play a visible or audible message to the user of the connected object, informing the user that a notification has been received and/or asking for the user's permission to allow their personal connected object to execute the instruction which is included in the notification. The notification server generates the audio tag described above.

FIG. 2 shows an example of a notification server. The notification server 200 may receive a request 142 from the third party, the request may include the instruction or instructions to be executed by the personal connected objects of potential users and optionally a message. The request may be sent by any known electronic communication means. According to an embodiment, the request also identifies one or more intermediary connected objects that are to receive the notification. According to another embodiment, the request simply comprises a notification type and, based on the notification type, the notification server works out which intermediary connected object or objects are to receive the notification. For this purpose, the notification server may optionally comprise a notification request analysis module 210. According to yet another embodiment, the notification server works out the type of notification on its own.

The notification server prepares an audio encoded version of the notification comprised within the notification request. According to an embodiment, the notification server comprises an alert sound selector 216, which may be configured to select an alert sound from a library of predetermined alert sounds to associate with the notification based, for example, on the notification type. An audio encoded version of the selected alert sound is then combined, blended or otherwise mixed with the audio encoded notification to provide the audio tag.

According to an embodiment, the alert sound may be a distinctive alert sound, recognisable by the person in the target environment such that the person associates it with an expectation that his or her personal connected object has just received an instruction and that he or she will be required to provide their consent, or permission, for their personal connected object to execute the instruction. According to some embodiments, the notification may comprise a message as well as the instruction and the personal connected object may display or otherwise present the message to the user requesting that the user provide their permission to execute the instruction. Since the person is aware of the instruction arriving, thanks to the audible component of the audio signal, they are not surprised at being asked to provide their permission to execute an instruction. The person may then decide whether to allow their personal connected object to execute the instruction. A particularly well-versed user may learn the different alert sounds, allowing them to recognise what type of notification has been received or even what they will be asked to do following the reception and decoding of the notification. However, they will always be able to rely on their personal connected object to confirm what was just received.

According to an embodiment, instead of selecting an alert sound, or combined with the selection of the alert sound, the notification server is configured to generate different alert sounds. The different alert sounds may be unique sounds. They could be unique to the type or category of notification, unique to a user, unique to an intermediary connected object or any combination of these. This feature may involve the use of one or more sound generative AI operations by the notification server for generating the different alert sounds.

The combination of the audio encoded alert sound and the audio encoded notification described above is known as an audio tag. The audio tag is sent in an electronic message to the target intermediary connected objects which are in environments where people who are likely to be concerned by the notifications are likely to be present, along with their suitably configured personal connected objects.

FIG. 3 shows an example of a process performed by an intermediary connected object 110. It is configured to receive 311 messages which are addressed to it, the messages comprising one or more audio tags 102, and to decode and play 321 the audio tags thus propagating an audio signal 120 into the environment using a speaker 314. According to an embodiment, the intermediate connected device is configured to repeat the playing of the audio signal 120 a predetermined number of times 331 before stopping the playback SP. By having the intermediary connected object repeat the playback of the audio tag a number of times, it is ensured that the user, after first hearing the alert sound as the intermediary connected object begins playing the decoded audio tag and propagating the audio signal along the propagation path, will then have enough time to take some action which will place their personal connected object into a mode which will allow it to pick up the audio signal in order to decode it to get the notification and to display a message describing the reason for the alert. This would be useful in a case where the user has not set their personal connected object to listen in background mode, for example. In this case, during the time over which the alert sound playback is being repeated, the user who hears the alert sound, alerting him or her to the fact that an audio tag is being sent from somewhere, has ample time to start an application on their personal connected object for processing audio tags before the alert sound stops and its corresponding audio tag is no longer available. By starting the application, this may provide permission for the microphone to be used. It is also possible for the right to use the microphone to be time-bound, so that when the audio tag decoding function has been performed the personal connected device can be returned to the mode where it does not listen in the background. This is in keeping with the aim of providing the personal connected object user with a precise control of which applications have access to which features for how long and for what purpose.

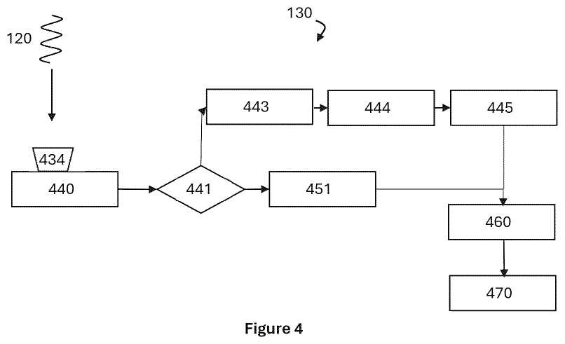

FIG. 4 shows an example embodiment of a personal connected object 130 and the operations it may perform when it receives an audio signal 120 via its microphone 434. According to an embodiment, the personal connected object may be authorised to perform passive listening, where it monitors any sounds in its environment and tries to determine whether the sound it picks up comprises an audio tag. In other embodiments, the personal connected object only activates its microphone when the user instructs it to do so. For example, when the user hears the alert sound, he or she may instruct their personal connected object to begin using its microphone to capture sounds in the environment and to check whether the sound it picks up comprises an audio tag.

In order for the personal connected object to be able to recognize 440 whether an audio signal it is detecting comprises an audio tag or whether an audible component of the audio signal it is detecting is an alert sound corresponding to an audio tag, the personal connected device may be configured to derive an audio fingerprint for the audio signal and to compare the derived audio fingerprint with a library of audio footprints of existing alert sounds and/or existing audio tags.

Depending on the embodiment of the personal connected object there may be one from two different ways in which the personal connected object can arrange for the decoding of the audio tag to provide the instruction encoded therein. According to a first embodiment, the personal connected object is configured to perform autonomous extraction 443 of the audio encoded notification from the audio tag captured via the microphone and to decode 444 the audio encoded notification therefrom and extract 445 the message and/or the instruction from the decoded notification. According to another embodiment, where the personal connected object operates in a “connected mode”, using the audio fingerprint derived by the personal connected object as an identifier of the alert sound or the audio tag, the personal connected object may query the notification server, requesting it to send back 451 the corresponding instruction and/or message via an electronic communication channel. In the non-connected mode, audio fingerprints may also be used to identify the alert sound or the audio tag.

When the instruction and/or the message have been obtained by the personal connected object, the user may be invited to intervene, for example by the personal connected object displaying a message on a screen or by otherwise playing the message, so that the user gets an opportunity to make known his or her intention to give or withhold their consent 460 for the personal connected object to execute 470 the instruction.

Embodiments described herein therefore provide for a third party to be able to send a notification comprising information to any person, or to a group of people, who are not necessarily known to the third party but who are likely to have an interest in receiving the information. By virtue of the person's presence in or around a particular environment, the likelihood of the person having an interest in receiving the information is reinforced. By addressing an electronic communication comprising an audio encoded signal comprising an audible component comprising an alert sound and an inaudible component comprising the information, to at least one predetermined connected object located at or near the particular environment and having the connected object play the audio encoded signal such that the person hears the alert sound and a suitably configured personal connected object of the person picks up the audio signal and decodes the information from the inaudible part of the signal and presents a message about the information to the user, the third party can ensure that the person will be alerted to having received the information and, should the information have included an instruction for execution by the personal connected object, the person will be given the opportunity to provide their consent for executing the instruction.

According to an embodiment, audio encoding of a notification, to produce said audio encoded notification, may include a data encoding step followed by one or more audio encoding operations including one or more digital watermarking algorithms and/or one or more spectral encoding algorithms and/or one or more dual-tone multi-frequency algorithms (DTMF) and/or one or more modulation encoding manipulations and/or the use of one or more sound generative AI operations.

According to an embodiment, the blending, mixing or combining of the audio encoded alert sound and the audio encoded notification to provide the audio tag may comprise generating an initial trigger sequence so that the personal connected object will be able to detect where the alert sound begins, before then blending the audio sequence having the trigger and the alert sound into the audio tag to provide the audible component of the resulting audio signal when decoded and blending the audio encoded notification into the audio tag to provide the inaudible component of the resulting audio signal when the tag is decoded.

The technology described herein may be applied in cases where a service provider wants to alert anyone who arrives at a certain physical location that he or she needs to take some action. In a vehicle environment for example, user interaction with a connected object of the vehicle can therefore be achieved via the user's smartphone without the need for the user to pair their connected object with the vehicle's connected object and without requiring any electronic connectivity channel for achieving the interactivity. Third parties may offer traffic information services, or emergencies, for example using data embedded into audio signals to trigger notifications on a user's smartphone. It is possible to implement enhanced prevention of driver distraction by allowing the driver to easily interact with the vehicle, through their smartphone, without the need for pairing. For example, a beep sound emitted by the vehicle to signal a low-battery status or to signal an anomaly with the charging function of the battery can include embedded data which causes a personal connected object to give a vocal warning about the battery condition. Similarly, a forward collision beep in a car, or an audio signal from a GPWS system on an aircraft, using the technology described herein, could be used to cause the personal connected object to provide a clear vocal warning about the impending danger, leaving the driver, or the pilot, in no doubt as to the meaning of the beep. In an advertising context, a third party may use the technology to cause a connected radio in the car to play a special jingle which can be decoded by a personal connected object to announce a special offer at a store nearby and upon consent from the user the personal connected object may guide the driver to the store.

Any audio signal may be used according to embodiments described herein to embed data: not just in an in-vehicle environment. For example, an airline company who comes across an overbooking problem and wants to present an opportunity to all passengers on the overbooked flight to be able to choose to fly the next day, perhaps for a cheaper price, could send an audio tag, an hour before the overbooked flight is scheduled to leave, to an intermediary connected device that it controls and which has a speaker and which is near the boarding gate. All passengers who are within earshot of the connected device and who have a suitable app on their personal connected devices would be able to receive a message informing them that they can change their flight and get some money back and if they want to let their connected device carry out the necessary interactions with the various computers and servers involved then they just have to give their consent, for example vocally, and the commands in the audio tag will be carried out for them on their personal connected devices.

Other scenarios where an embodiment of the technology described herein may find use include the following:
(i) An emergency vehicle equipped with V2X technology is approaching an intersection with heavy traffic. Using its V2X system, the vehicle broadcasts an audible warning signal to nearby vehicles and pedestrians, alerting them to yield and make way for the approaching emergency vehicle. Connected devices, such as smartphones or smartwatches carried by individuals in the vicinity, receive synchronized audible alerts, ensuring everyone is aware of the emergency vehicle's presence and can facilitate its passage safely and efficiently.
(ii) A ride-hailing application user hails a ride and is matched with a driver. As the user enters the driver's vehicle, the user's smartphone application triggers the vehicle to emit a unique startup sound associated with the passenger's profile. When the vehicle's audio system personalized audio signal tailored to the user's profile, this signals to both the driver and the user that the correct individual is present in the vehicle. This audible confirmation enhances security and helps prevent unauthorized individuals from entering the vehicle. Upon hearing the personalized startup sound, the user may their identity through the ride-hailing application. Once verified, the driver can commence the ride with confidence, knowing that the correct passenger is onboard, thereby streamlining the pickup process and ensuring a seamless and secure experience for both parties.
(iii) An adult is driving with a child of a relative/friend in the car. Upon starting the vehicle, a specific audio signal is emitted to confirm any passenger presence. An application installed on the child's smartwatch is configured to detect the unique audio signal emitted upon vehicle startup. Upon starting the car, the car's audio system emits a distinct startup sound associated with the detection of the passenger. The child's smartwatch application picks up this signal and the child confirms their presence in the vehicle, allowing to provide real-time reassurance to the parent who receives the confirmation message from the child's smartwatch that the child is in the specific car.

1. A method for eliciting consent from a user to allow a personal connected object of the user to execute an instruction, the method comprising communication of the instruction to said personal connected object, said communication including:
receiving at one or more predetermined electronically addressable intermediary connected objects located at one or more target environments, via an electronic communication channel, an audio tag comprising:
an audio encoded notification comprising the instruction; and
an audio encoded alert sound;
decoding and playing the audio tag by the intermediary connected object, thus propagating an audio signal towards the personal connected object over a propagation path in the target environment, the audio signal comprising an audible component and an inaudible component as perceivable by a person located within the propagation path, the audible component comprising the alert sound and the inaudible component comprising the audio encoded notification;
receiving the propagated audio signal by a microphone of the personal connected object;
recognizing, by the personal connected object, that the audio signal comprises an audio tag or that the audio signal comprises an audio encoded alert sound;
arranging, by the personal connected object, for the instruction within the audio encoded notification in the audio tag to be obtained;
presenting, by the personal connected object, the instruction to the user for the user to provide said consent.

2. The method according to claim 1, further comprising executing the instruction by the personal connected object on condition that the user provided said consent.

3. The method according to claim 1, wherein said recognition that the audio signal comprises an audio tag or that the audio signal comprises an audio encoded alert sound is provided by the personal connected object being configured to derive an audio fingerprint of the audio tag or of the alert sound, the method comprising searching for a match between the thus derived audio fingerprint and a predetermined audio fingerprint within a database of predetermined audio fingerprints derived from known audio tags or alert sounds, said recognition being positive when the match is found.

4. The method according to claim 1, wherein said audio tag is received from a notification server, the method further comprising:
receiving, by the notification server, a request to send said instruction for the attention of one or more users having personal connected objects located within an audible physical range from at least one of said intermediary connected objects;
generating, by the notification server, said audio tag by combining an audio encoding of the alert sound with an audio encoding of the instruction such that when the audio tag is decoded to provide the audio signal, the alert sound is comprised within the audible component of the audio signal and the instruction is comprised within the inaudible component of the audio signal.

5. The method according to claim 1, wherein said arrangement for the instruction to be obtained is provided by the personal connected object being configured to extract and decode the instruction from the audio encoded notification within the inaudible component of the propagated audio signal, the method comprising extracting and decoding the instruction from the audio encoded notification.

6. The method according to claim 4, wherein said arrangement for the instruction to be obtained is provided by the personal connected object having electronic communication access to the notification server, the method further comprising requesting from the notification server, by the personal connected object, the instruction from the audio tag having an audio fingerprint which matches the audio fingerprint derived from the audio tag.

7. The method according to claim 1, wherein said audio encoded notification is produced by encoding said instruction and performing one or more audio encoding operations on the encoded notification from one or more of: a watermarking operation; a spectral encoding operation; a dual-tone multifrequency operation; a modulation encoding operation; and one or more sound generative AI operations.

8. The method according to claim 7, wherein the audio tag is created by combining said audio encoded notification with said alert sound, said combination being preceded by an auditory cue to trigger the personal connected object to extract the audio fingerprint from the audio tag.

9. The method according to claim 1, wherein said alert sound is a customized alert sound selected from a plurality of alert sounds depending on a category to which the instruction belongs.

10. The method according to claim 9, wherein said customized alert sound is generated using one or more sound generative AI operations.

11. A propagating audio signal comprising an audible component and an inaudible component as perceivable by a person located within a propagation path along which the audio signal propagates, the audible component comprising an alert sound, the inaudible component comprising an audio encoded notification comprising an instruction executable by a processor.

12. A non-transitory machine-readable medium having stored thereon machine-readable instructions executable to cause a machine to perform the method according to claim 1.

13. A system for eliciting consent from a user to allow a personal connected object of the user to execute an instruction, the personal connected object comprising a microphone, the system comprising an intermediary connected object and a notification server, the intermediary connected object having a speaker, the intermediary connected object being configured to receive an audio tag from the notification server via an electronic communication channel, the audio tag comprising:
an audio encoded notification comprising the instruction; and
an audio encoded alert sound;
wherein:
the intermediary connected object is configured to play the audio tag, thus propagating an audio signal towards the personal connected object, the audio encoded alert sound being audible within the audio signal and the audio encoded notification being inaudible within the audio signal; and
the personal connected object is configured to recognize that the audio signal comprises the audio encoded notification and to obtain the instruction encoded within the audio encoded notification and to seek the consent from the user of the personal connected object to execute the instruction.

14. An intermediary connected object for use in the system according to claim 13.

15. A personal connected object for use in the system according to claim 13.
